(19) United States
(12) Patent Application Publication
(10) Pub. No.: US 2014/0254156 A1
(43) Pub. Date: Sep. 11, 2014

(54) LIGHTING DEVICE

(71) Applicant: Genius Electronic Optical Co., Ltd., Taichung City (TW)

(72) Inventors: Hui-Ju Hsu, Taichung City (TW); Zin-Cheng Lin, Taichung City (TW)

(73) Assignee: Genius Electronic Optical Co., Ltd., Taichung City (TW)

(21) Appl. No.: 14/198,318

(22) Filed: Mar. 5, 2014

(30) Foreign Application Priority Data
Mar. 11, 2013 (TW) 102108501

(51) Int. Cl. F21V 19/02; F21V 23/00

(52) U.S. Cl. CPC F21V 19/02; F21V 23/009
USPC 362/249.1; 362/249.11

(57) ABSTRACT

A lighting device includes a main body having a bottom portion, two lateral portions extending upwardly and respectively from two opposite ends of the bottom portion toward each other, and a connecting tube formed on the bottom portion and located between the lateral portions. The connecting tube has one end that faces a rear end of the main body and that is open for communicating the connecting tube with the outside of the main body and for insertion of a lamp post therein. A light emitting module is disposed on the main body and includes a plurality of light emitting elements. An electrical box is fixed to a front end of the main body and housing a circuit module that is electrically connected to the light emitting elements.

### BACKGROUND OF THE INVENTION

1. Field of the Invention

This invention relates to a lighting device, and more particularly to a lighting device for connection with a lamp post.

2. Description of the Related Art

A conventional lighting device usually has a mounting frame additionally provided on an external portion of a lamp body, after which the mounting frame is connected to a lamp post. However, use of the mounting frame only increases the cost of the conventional lighting device. To resolve this problem, the lighting device has been developed to directly connect the lamp body to the lamp post.

Currently existing lighting devices typically require intelligence to conform to the use requirements. For example, if the lighting device is disposed outdoor, it should be able to detect the current intensity of sunlight in order to determine whether to provide illumination, or to detect whether additional cooling is needed so that a cooling mechanism may be activated (for example, a fan). Thus, an existing lighting device usually has an electrical box to connect with a lamp body and a lamp post, and an interior of the electrical box is disposed with related intelligent circuit elements to perform an electrical function.

An example of the aforesaid lighting device is disclosed in Taiwanese Patent Publication No. M422628. In this case, the lighting device has an electrical box located between a lamp body and a lamp post. However, such a structure has the following drawbacks which need improvement:
1. An outer side of the electrical box must be provided with a mounting frame so as to dispose the electrical box and the lamp on the lamp post. Use of the mounting frame results in increasing the cost of the lighting device.
2. Since an interior of the electrical box is disposed with an electronic element, an issue of heat dissipation has to be put into consideration, so that the interior of the electrical box should be spacious.
3. Because the lamp post must be connected with the electrical box, the electrical box must allocate a definite space for coupling with the lamp post, so that the size of the electrical box must be enlarged. This not only affects the appearance of the lighting device, but also causes an increase in the cost thereof.

### SUMMARY OF THE INVENTION

Therefore, an object of the present invention is to provide a lighting device that is capable of overcoming the aforementioned drawbacks of the prior art.

According to this invention, a lighting device comprises a main body, a light emitting module and an electrical box. The main body includes a bottom portion, two lateral portions extending upwardly and respectively from two opposite ends of the bottom portion toward each other, and a connecting tube formed on the bottom portion and located between the lateral portions. The connecting tube has one end that faces a rear end of the main body and that is open for communicating the connecting tube with the outside of the main body and for insertion of a lamp post therein. The light emitting module is disposed on the main body and includes a plurality of light emitting elements. The electrical box is fixed to a front end of the main body and houses a circuit module that is electrically connected to the light emitting elements.

Thus, this invention has fewer structural components than that of the conventional lighting device, so that the manufacturing cost thereof can be effectively reduced. Further, the size of the lighting device is small so that the appearance thereof can be enhanced.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a top perspective view of a lighting device according to the preferred embodiment of the present invention;

FIG. 2 is a bottom perspective view of the preferred embodiment;

FIG. 3 is an exploded perspective view of FIG. 2;

FIG. 4 illustrates how a circuit module is disposed in a box body of an electrical box;

FIG. 5 is an assembled sectional view of FIG. 4;

FIG. 6 is a schematic side view of the preferred embodiment, illustrating how a cover is pivoted to the box body; and

FIG. 7 illustrates how a lamp post is connected to the lighting device of the preferred embodiment.

### DETAILED DESCRIPTION OF THE PREFERRED EMBODIMENT

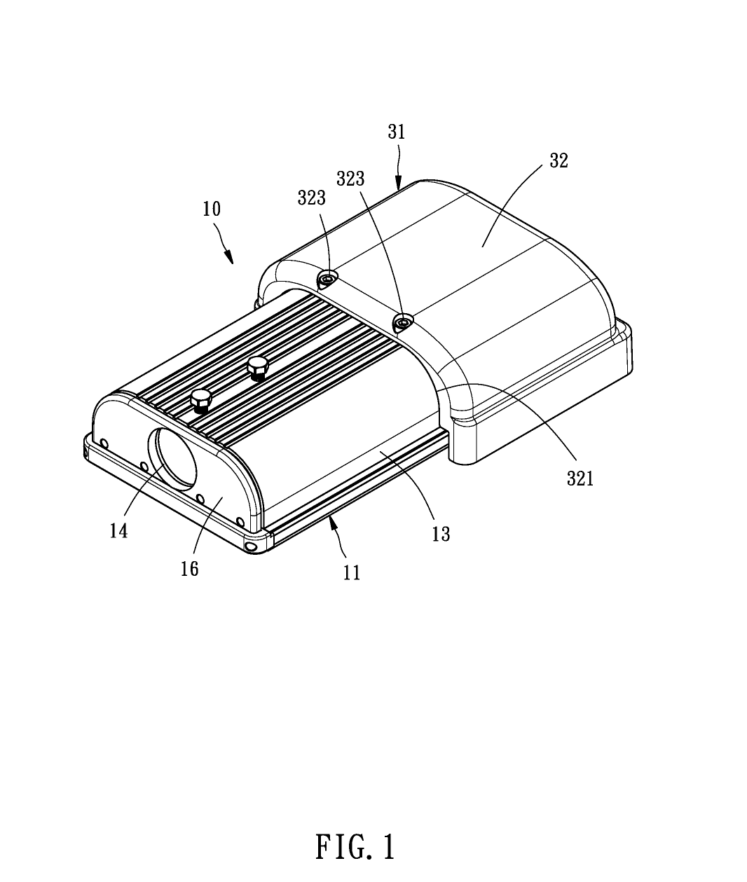

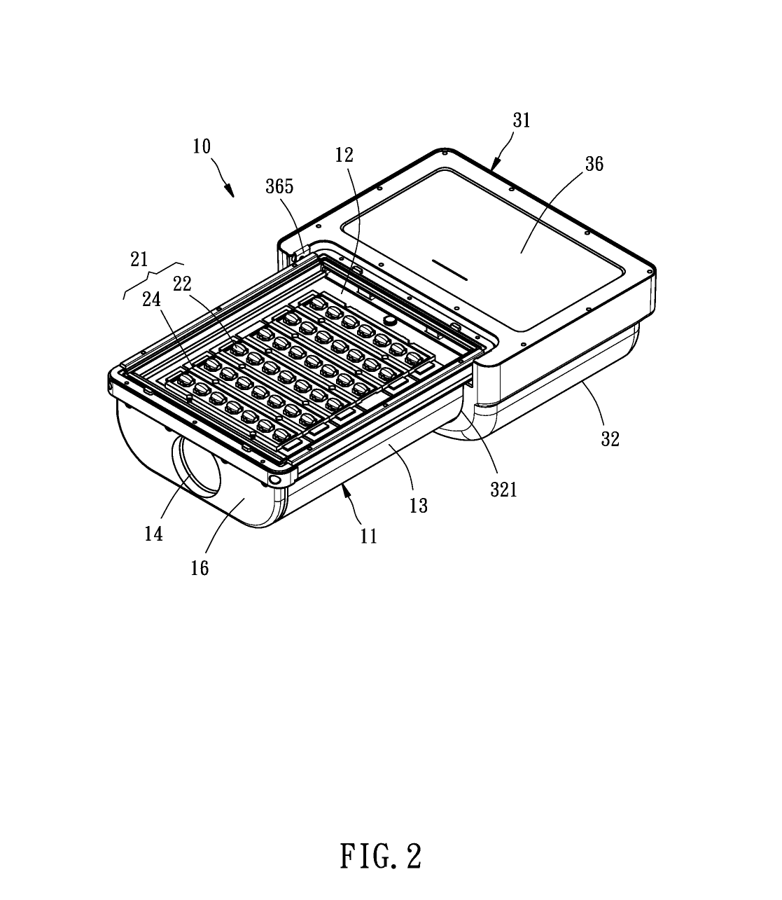

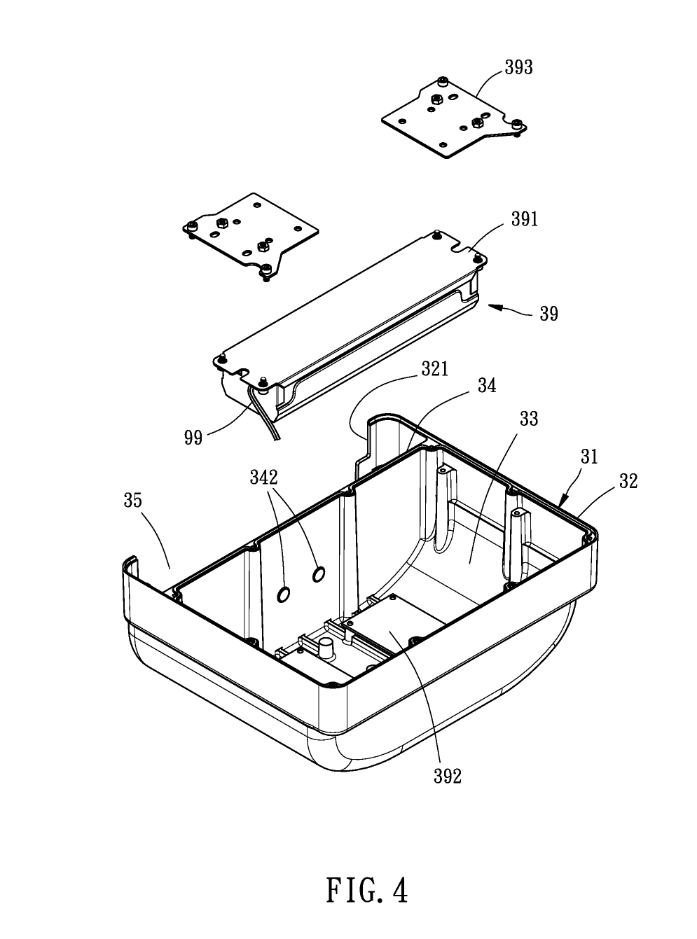

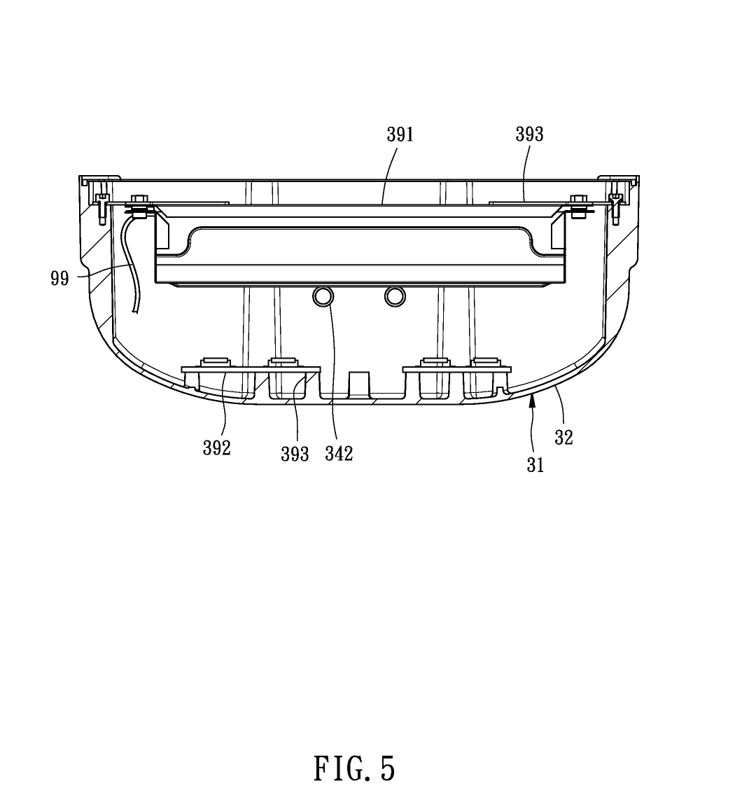

Referring to FIGS. 1 to 6, a lighting device 10 according to the preferred embodiment of this invention comprises a main body 11, a light emitting module 21 and an electrical box 31.

The main body 11 includes a bottom portion 12, two lateral portions 13 extending upwardly, curvedly, and respectively from two opposite ends of the bottom portion 12 toward each other, and a connecting tube 14 formed on the bottom portion 12 and located between the lateral portions 13. One end of the connecting tube 14 faces a rear end of the main body 11, and is open for communicating the connecting tube 14 with the outside of the main body 11. In this embodiment, front and rear ends of the main body 11 are respectively provided with an end cap 16. The end cap 16 located at the rear end of the main body 11 has an aperture 161 communicating with the opened end of the connecting tube 14 for insertion of an upper end of a lamp post 91 therethrough so that the lamp post 91 may be connected with the connecting tube 14. Further, in this embodiment, the bottom portion 12, the lateral portions 13 and the connecting tube 14 are molded integrally as one piece by aluminum extrusion.

The light emitting module 21 is disposed on the bottom portion 12 of the main body 11, and includes a plurality of light emitting elements 22. In this embodiment, the light emitting elements 22 are disposed on a plate body 24, after which the plate body 24 is fixed to the bottom portion 12 of the main body 11. The light emitting elements 22 are exemplified as light emitting diodes.

The electrical box 31 is fixed to the front end of the main body 11, and houses a circuit module 39. The circuit module 39 is electrically connected to the light emitting elements 22 through an electrical wire 99. The electrical wire 99 extends through the electrical box 31 and is connected to the light emitting elements 22. In this embodiment, the electrical box 31 includes a box body 32 and a cover 36 covering the box body 32.

A rear side of the box body 32 is provided with a cutout portion 321 to allow a portion of the front end of the main body 11 to enter the box body 32, so that the main body 11 is connected to the box body 32. The box body 32 is provided with a plurality of through holes 322 located in proximity to the cutout portion 321. A plurality of fastening elements 323 extend through the respective through holes 322 to fix the main body 11 to the box body 32. In this preferred embodiment, the fastening elements 323 are screw bolts. Further, a partition wall 34 is provided in the box body 32 to divide the box body 32 into a first receiving section 33 and a second receiving section 35. The second receiving section 35 is adjacent to the cutout portion 321. The circuit module 39 is received in the first receiving section 33. The portion of the front end of the main body 11 is received in the second receiving section 35 so that the main body 11 is partially covered by the box body 32. Moreover, the partition wall 34 has at least one aperture 342 for extension of the electrical wire 99 therethrough, so that the electrical wire 99 can electrically connect the circuit module 39 with the light emitting elements 22.

In this embodiment, the circuit module 39 includes a power supply control unit 391 and an intelligent module 392. The power supply control unit 391 is fixed to the box body 32 in proximity to the cover 36 through a fixing unit 393. The intelligent module 392 is fixed to supporting studs 394 of the box body 32 which are located distal from the cover 36 by using a fastening unit, such as screws or adhesive. Through this, the power supply control unit 391 is suspended inside the box body 32 and is distal from the intelligent module 392 so as to increase space inside the box body 32. Heat generated in the power supply control unit 391 cannot be easily transmitted to the intelligent module 392, thereby prolonging the service lives of both of the power supply control unit 391 and the intelligent module 392. However, the implementation of this invention is not limited as such. The power supply control unit 391 may not be suspended in the box body 32 so as to reduce the size and the manufacturing cost of the electrical box 31.

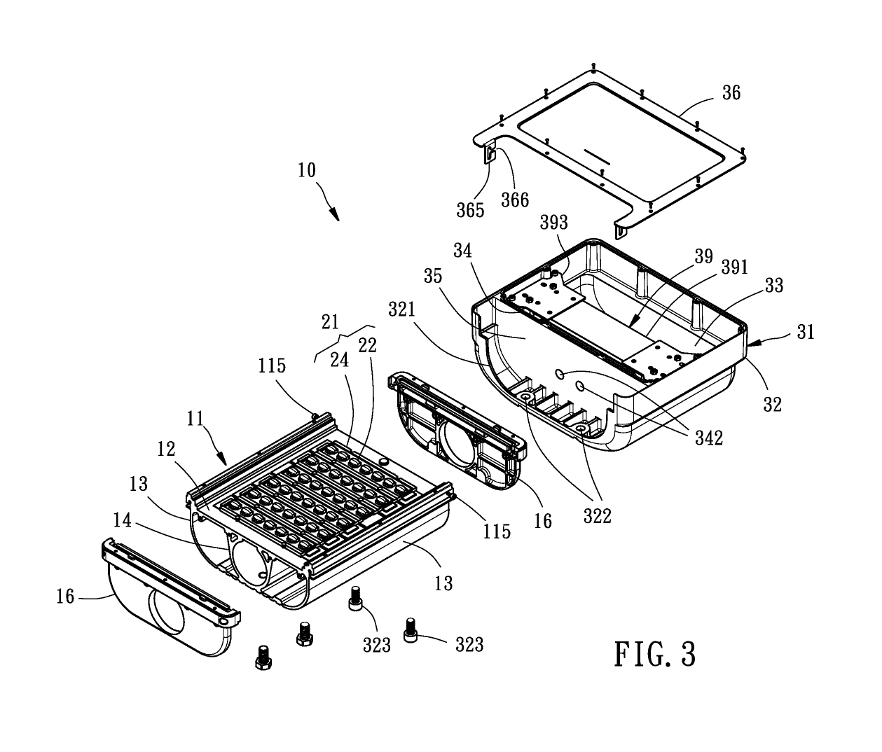

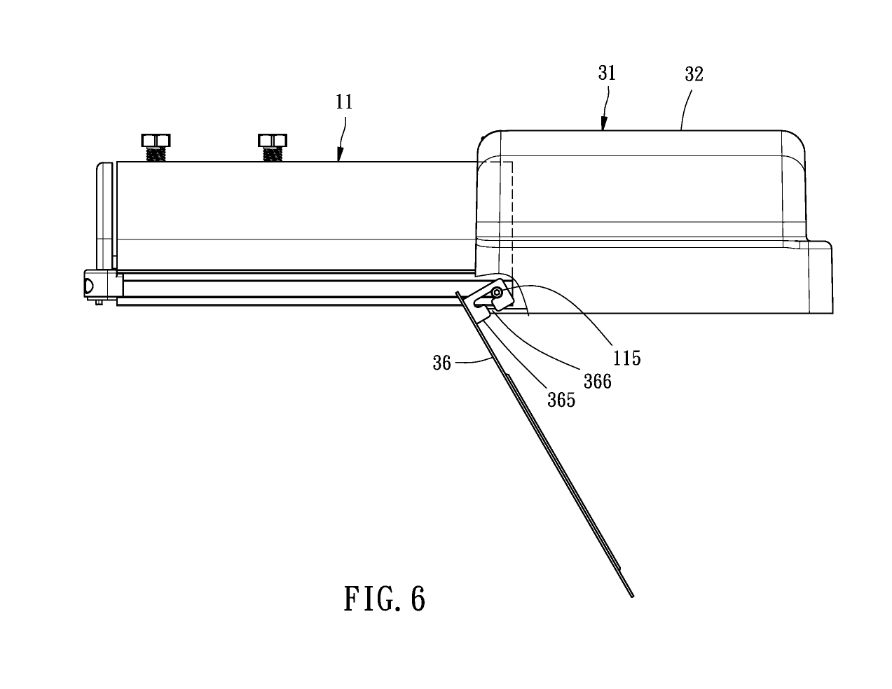

The cover 36 has a pair of connecting portions 365 connected pivotally and respectively to a pair of coupling portions 115 of the main body 11 so that the cover 36 is pivotable relative to the box body 32 to cover and uncover the box body 32. As shown in FIGS. 3 and 6, each coupling portion 115 of the main body 11 is configured as a bolt, and each connecting portion 365 of the cover 36 is C-shaped and has an opening 366. By inserting each coupling portion 115 into a respective connecting portion 365 via the opening 366, each coupling portion 115 is engaged movably to the respective connecting portion 365. The opening 366 is provided to allow assembly of the cover 36 after the main body 11 and the electrical box 31 are assembled, thereby enhancing the convenience of assembly. In other alternative embodiments, each connecting portion 365 may not have the opening 366, and the order of assembly may be different.

The aforesaid description relates to the structure of this embodiment. The operation and effect of this embodiment will be described hereinbelow.

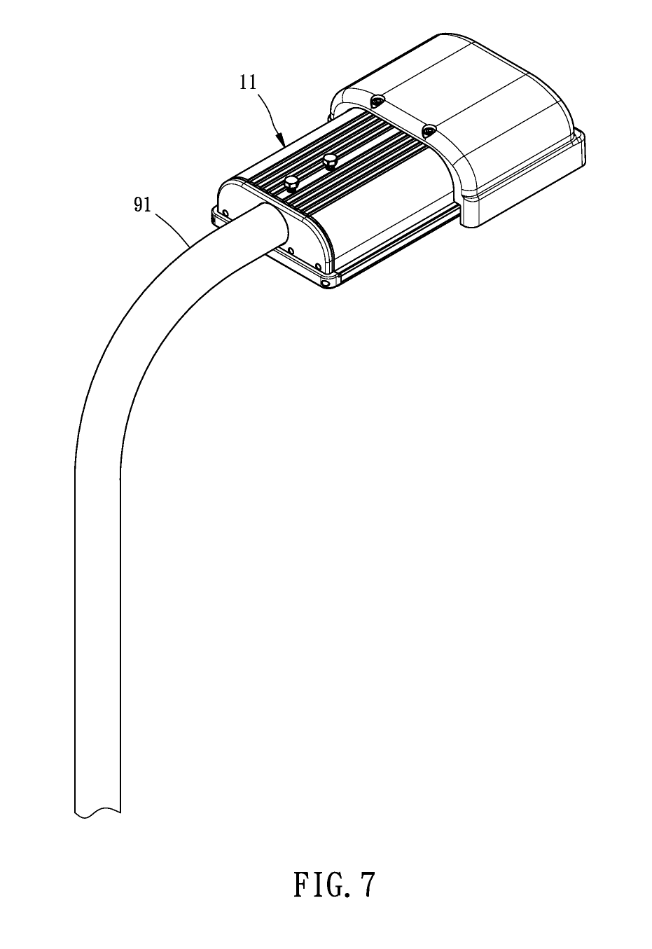

Referring to FIG. 7, the lamp post 91 is connected to the rear end of the main body 11. Specifically, the lamp post 91 is directly inserted into the connecting tube 14 (see FIG. 3) through the aperture 161 in the end cap 16 which is located at the rear end of the main body 11 and through the opened end of the connecting tube 14. Connect a power supply (not shown), and the lighting device 10 can be put into use. Hence, installation is easy.

Because the electrical box 31 is disposed at the front end of the main body 11, it will not interfere with the lamp post 91 which is located at the rear end of the main body 11. The problem of having to increase the size of the electrical box to accommodate connection with the lamp post in the conventional lighting device can thus be resolved. Hence, the size of the electrical box 31 not only can be reduced, the associated manufacturing cost can also be minimized.

Furthermore, because there is no need to use the mounting frame described in the prior art for connection with the lamp post 91, when compared with the conventional lighting device, the lighting device 10 of this invention has fewer components, is smaller in size, and is more aesthetic in appearance.

To repair the circuit module 39, the cover 36 is pivoted relative to the box body 32 to uncover the box body 32. At this time, each connecting portion 365 is hooked to the respective coupling portion 115 so that the cover 36 will not fall off. Hence, during repair, there is no need to worry about losing the cover 36, thereby enhancing the convenience of repair.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A lighting device comprising a main body, characterized by:
said main body including a bottom portion, two lateral portions extending upwardly and respectively from two opposite ends of said bottom portion toward each other, and a connecting tube formed on said bottom portion and located between said lateral portions, said connecting tube having one end that faces a rear end of said main body and that is open for communicating said connecting tube with the outside of said main body and for insertion of a lamp post therein;
a light emitting module disposed on said main body and including a plurality of light emitting elements; and
an electrical box fixed to a front end of said main body and housing a circuit module that is electrically connected to said light emitting elements.

2. The lighting device as claimed in claim 1, wherein said electrical box includes a box body and a cover covering said box body.

3. The lighting device as claimed in claim 2, wherein said main body has a pair of coupling portions, said cover having a pair of connecting portions connected pivotally and respectively to said pair of coupling portions so that said cover is pivotable relative to said box body to cover or uncover said box body.

4. The lighting device as claimed in claim 3, wherein each of said coupling portions is configured as a bolt, each of said connecting portions being C-shaped and having an opening for insertion of one of said coupling portions into a respective one of said connecting portions, each of said coupling portions being engaged movably to the respective one of said connecting portions.

5. The lighting device as claimed in claim 2, wherein a rear side of said box body is provided with a cutout portion to allow a portion of said front end of said main body to enter said box body, so that said main body is connected to said box body.

6. The lighting device as claimed in claim 5, wherein said box body is provided with a plurality of through holes located in proximity to said cutout portion, said lighting device further comprising a plurality of fastening elements that respectively extend through said through holes to fix said main body to said box body.

7. The lighting device as claimed in claim 5, wherein said box body has a partition wall to divide said box body into a first receiving section and a second receiving section, said second receiving section being adjacent to said cutout portion, said circuit module being received in said first receiving section, said portion of said front end of said main body being received in said second receiving section so that said main body is partially covered by said box body.

8. The lighting device as claimed in claim 7, wherein said partition wall has at least one aperture, said circuit module having an electrical wire that extends through said aperture to electrically connect said circuit module with said light emitting elements.

9. The lighting device as claimed in claim 2, wherein said circuit module includes a power supply control unit and an intelligent module, said power supply control unit being fixed to said box body through a fixing unit, said power supply control unit being suspended inside said box body.

10. The lighting device as claimed in claim 1, further comprising two end caps respectively provided on said front and rear ends of said main body, said end cap located at said rear end of said main body having an aperture for communicating said one end of said connecting tube with the outside of said main body.
